(19) United States
(12) Patent Application Publication
(10) Pub. No.: US 2011/0289329 A1
(43) Pub. Date: Nov. 24, 2011

(54) LEVERAGING SMART-METERS FOR INITIATING APPLICATION MIGRATION ACROSS CLOUDS FOR PERFORMANCE AND POWER-EXPENDITURE TRADE-OFFS

(76) Inventors: Sumit Kumar Bose, Karnataka (IN); Michael A. Salsburg, Pennsylvania, PA (US); Mohammad Firoj Mithanl, Karnataka (IN)

(21) Appl. No.: 12/893,415

(22) Filed: Sep. 29, 2010

Related U.S. Application Data
(60) Provisional application No. 61/346,052, filed on May 19, 2010.

(51) Int. Cl. G06F 1/32

(52) U.S. Cl. 713/320

(57) ABSTRACT

Managing power expenditures for hosting computer applications. A smart meter can receive electricity pricing information for a data center or other group of computing resources that host computer applications, such as a cloud computing environment. An application manager to determine how much electricity can be saved by operating the applications at a reduced performance level without compromising performance metrics for the applications. A site broker can determine how to sequence the performance levels of the applications to meet an electricity usage budget or to otherwise reduce electricity consumption or costs, for example during a peak load time period. The site broker can also select one or more applications to migrate to another cloud to meet the electricity usage budget or to reduce electricity consumption or costs. A hybrid cloud broker can interact with the site broker to migrate the selected application(s) to another cloud.

### CROSS REFERENCE TO RELATED APPLICATIONS

This non-provisional patent application claims priority under 35 U.S.C. §119 to U.S. Provisional Patent Application No. 61/346,052, entitled “Leveraging Smart-Meters for Initiating Application Migration Across Clouds for Performance and Power-Expenditure Trade-offs,” filed May 19, 2010.

### TECHNICAL FIELD

The instant disclosure relates generally to hosting computer applications, and more particularly to systems and methods for leveraging smart meters to manage power expenditures associated with hosting the applications.

### BACKGROUND

Smart meters enable power distribution companies to price electricity differently for different parts of the day or based on varying load conditions. Such dynamic pricing schemes help the distribution companies to manage the aggregate demand of electricity based on available supply. To manage electricity demand, distribution companies can increase electricity prices during high cost peak usage periods, while reducing electricity costs during low demand periods. Information regarding such dynamically varying pricing is communicated by the distribution companies to their consumers using smart-grid technologies, for example, as part of a Demand Response (DR) program.

Modern server rooms, typically referred to as data centers, often contain hundreds and thousands of servers that, in turn, host a large number of applications. Many large organizations have multiple such data centers spread across different geographies. The cost of managing such large computing infrastructures can be extremely expensive. In view of these costs, it is important to execute applications in an efficient manner.

### SUMMARY

Managing electricity consumption of computing infrastructure during high cost peak electricity usage periods can be critical considering that as much as half the billed amount could be due to electricity consumed during these peak electricity usage periods, which occur for a relatively small fraction of the day. Thus, a need exists in the art for methods and systems for managing electricity consumption of computing resources during peak electricity usage periods.

The systems and methods described herein attempt to manage power expenditures for hosting computer applications. A smart meter can receive real time (or near real time) electricity pricing information for a data center or other group of computing resources that host computer applications, such as a cloud computing environment. One or more application managers can manage one or more applications and resources (e.g., servers) that host the applications. The application manager(s) can allocate these resources to the applications in a manner that reduces electricity consumption and/or electricity expenditures without compromising the applications' service level agreements (e.g., required response time, availability, etc.). A site broker can receive the electricity pricing information from the smart meter and interact with each application manager at a data center or cloud computing environment to reduce total electricity consumption during adverse power grid load situations where electricity prices are higher than normal. These site brokers can also identify applications to migrate to a cloud computing environment (or to another cloud computing environment) if appropriate. The site brokers can communicate information regarding the identified applications to a hybrid cloud broker. For each identified application, the hybrid cloud broker can determine, from a set of cloud computing environments, to which cloud computing environment the application should be migrated. The hybrid cloud broker can initiate the migration of the identified application(s) to the determined cloud computing environment.

According to one embodiment, a computer-implemented method for reducing electricity consumption for a group of computers hosting applications can include analyzing each application to determine a time duration that the application can be executed at a reduced performance level without compromising at least one performance metric associated with the application. A sequence for executing the applications at reduced performance levels for a time period based on the time duration for each application can be generated where total electricity consumed by the applications meets an electricity usage budget throughout the time period. The applications can be executed according to the sequence.

According to another embodiment, a computer-implemented method for reducing electricity consumption for a first group of computers hosting applications can include receiving a request to reduce an amount of electricity consumed by the first group of computers to a level below a budgeted amount of electricity for a time period. Each application can be analyzed to determine a time duration that the application can be executed at a reduced performance level without compromising at least one performance metric associated with the application. Based at least on the time duration that each application can be executed at a reduced performance level, the applications can be evaluated to determine whether they can be executed in a sequence of varying performance levels which meets the budgeted amount of electricity can be determined. Based on a determination that the applications cannot be sequenced to meet the budgeted amount of electricity, one or more of the applications can be selected to be transferred to a second group of computers and the selected one or more of the applications can be transferred to the second group of computers. Based on a determination that the applications can be sequenced to meet the budgeted amount of electricity, a sequence for executing the applications at reduced performance levels based on the time duration that each application can be executed at a reduced performance level can be generated and the applications can be executed according to the generated sequence.

According to yet another embodiment, a system can include computers for hosting applications. At least one application manager can manage execution of at least one of the applications on a portion of the computers. A site broker communicably coupled to the at least one application manager can determine a sequence for executing the applications in a manner to not exceed a power budget for a time period without compromising a performance metric associated with each application. Each application can be executed in the sequence at a reduced performance level for at least a portion of the time period.

These and other aspects, features, and embodiments of the invention will become apparent to a person of ordinary skill in the art upon consideration of the following detailed description of illustrated embodiments exemplifying the best mode for carrying out the invention as presently perceived.

### BRIEF DESCRIPTION OF THE DRAWINGS

The preferred embodiments of the present invention are illustrated by way of example and not limited by the following figures:

FIG. 1 shows a system for managing electricity expenditure for applications hosted in a cloud computing environment, in accordance with certain exemplary embodiments.

FIG. 2 shows a flow diagram of a method for reducing electricity expenditure associated with hosting applications in a cloud computing environment, in accordance with certain exemplary embodiments.

FIG. 3 shows a flow diagram of a method for analyzing an application to determine possible electricity savings and how to operate resources, in accordance with certain exemplary embodiments.

FIG. 4 shows a flow diagram of a method for executing an algorithm to determine which server(s) can be powered down and a frequency for operating powered server(s), in accordance with certain exemplary embodiments.

The drawings illustrate only exemplary embodiments and are therefore not to be considered limiting of the scope of the disclosure, as the invention may admit to other equally effective embodiments. The elements and features shown in the drawings are not necessarily to scale, emphasis instead being placed upon clearly illustrating the principles of the exemplary embodiments. Additionally, certain dimensions may be exaggerated to help visually convey such principles. In the drawings, reference numerals designate like or corresponding, but not necessarily identical, elements.

### DETAILED DESCRIPTION

Systems and methods described herein manage power expenditures for hosting computer applications. A smart meter can receive electricity pricing information for a data center or other group of computing resources that host computer applications, such as a cloud computing environment. An application manager can determine how much electricity can be saved by operating the applications at a reduced performance level without compromising performance metrics for the applications. A site broker can determine how to sequence the performance levels of the applications to meet an electricity usage budget or to otherwise reduce electricity consumption or costs, for example during a peak load time period. The site broker can also select one or more applications to migrate to another cloud to meet the electricity usage budget or to reduce electricity consumption or costs. A hybrid cloud broker can interact with the site broker to migrate the selected application(s) to another cloud.

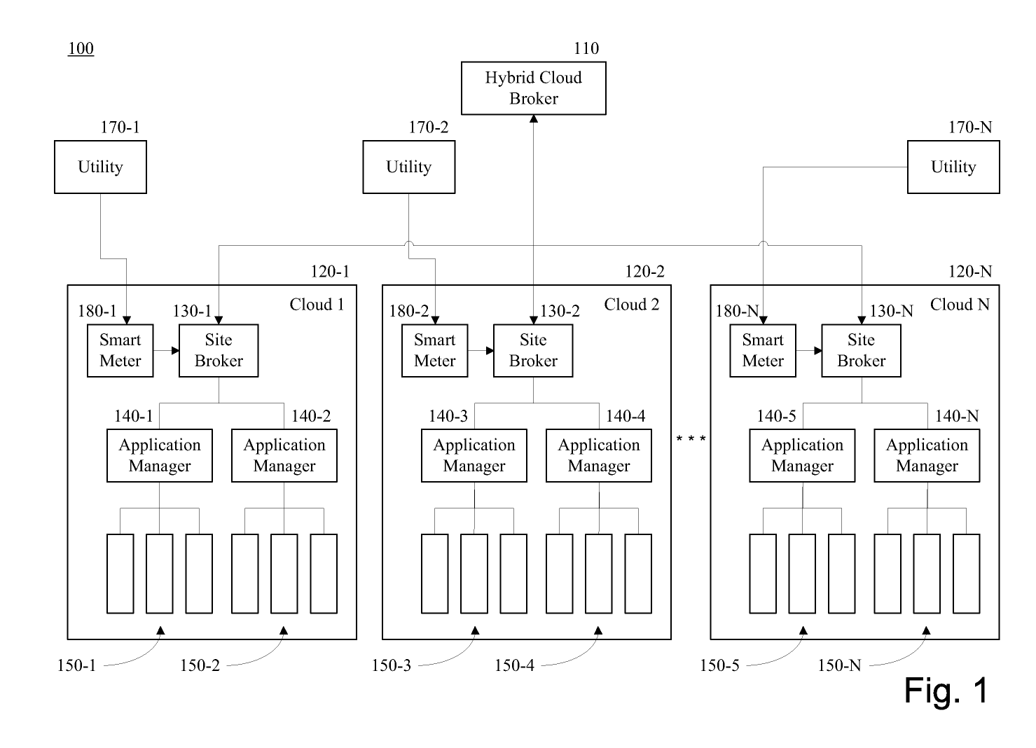

Turning now to the drawings, in which like numerals represent like (but not necessarily identical) elements throughout the figures, the exemplary embodiments illustrated therein are described in detail. FIG. 1 illustrates a system 100 for managing electricity expenditure for applications hosted in a cloud computing environment, in accordance with certain exemplary embodiments. Although the exemplary system 100 is described in terms of a cloud computing environment, aspects of the system 100 can be applied to private data centers, combinations of private data centers and cloud computing environments and other types of computing environments.

Referring to FIG. 1, the system 100 includes a number ‘n’ of cloud computing environments “clouds” 120, each having a site broker 130 communicably coupled to a hybrid cloud broker (HCB) 110. As described in greater detail below the HCB 110 facilitates moving a computer application from a first cloud, such as cloud 120-1, to a second cloud, such as cloud 120-2. The HCB 110 may be managed or otherwise associated with an organization that provides multiple clouds 120, each located in different geographic areas, including in different countries. For example, a cloud provider may provide public cloud computing services and maintain public cloud sites in different geographical areas. In another example, a large corporation may maintain private cloud sites in multiple geographic areas. Thus, in certain exemplary embodiments, the clouds 120 may be public clouds, private clouds, or hybrid clouds having both public and private clouds. Further, each cloud 120 can be thought of as a data center that is an individual consumer of electricity.

Each cloud 120 includes one or more servers 150 and other computing resources that together host one or more computing applications. Each cloud 120 also includes a smart meter 180 communicably coupled to a utility 170 that provides electricity to the cloud 120 via a communication network (not shown). The smart meter 180 records electricity consumption by the respective cloud 120 in time intervals, for example of an hour or less, and communicates the electricity consumption to the utility 120 for monitoring and billing purposes.

The utility 170 provides real time (or near real time) electricity pricing information to the smart meter 180 via the communication network. This pricing information may indicate the prices that the utility 170 charges the provider of the cloud 120 for consuming electricity at certain times (e.g., peak power grid load). The pricing information may also indicate a penalty that the cloud provider will incur if the cloud provider fails to curtail its consumption of electricity provided by the utility 170 during these times. This penalty may be based on the cloud 120 exceeding a budget of electricity that may be communicated with the pricing information. For example, the clouds 120 may be a member of a Demand Response (DR) program and the pricing information may be sent to the smart meters 180 as DR signals. A DR program is a mechanism for managing consumer's electricity consumption in response to supply conditions. For example, if electricity demand is high relative to supply, the utility 170 may increase electricity prices to motivate consumers to reduce their electricity consumption as part of a DR program. The utility 170 can also communicate a time period for a peak load condition in which the cloud 120 must curtail its electricity consumption.

As the resources (e.g., servers 150 and other equipment) of each cloud 120 may reside in different geographical areas, the clouds 120 may receive electricity from different utilities 170. In addition, the geographical separation between clouds 120 may result in the one or more clouds 120 being subject to higher peak demand electricity prices at different times than other clouds 120. Generally, peak power grid load conditions occur during the daylight hours when people are awake and active. For example, a first utility 170-1 may experience peak load conditions between the hours of 11 AM and 4 PM in the first utility's time zone. If a second utility 170-2 is in a different time zone separated by more than five hours from the first time zone and experiences peak load conditions between the hours of 11 AM and 4 PM in that different time zone, then the two utilities 170-1 and 170-2 would experience peak load conditions at different times with no overlap. In another example, a first cloud 120-1 may be located in the United States, while a second cloud 120-2 is located in China. In this example, one of the clouds 120-1 would be operating during the night while the other cloud 120-2 is operating during the day.

Each exemplary cloud 120 includes a site broker 130 and one or more application managers 140 communicably coupled to the site broker 130. The site brokers 130 and application managers 140 can be embodied as software applications executing on one or more servers. The application managers 140 are responsible for managing one or more applications locally at a cloud site and for trading off the performance of the application(s) for savings in power consumption without compromising the applications' service level agreements (SLAs). Application SLAs specify performance metrics that must be met by a service provider, such as a cloud provider. The performance metrics of an SLA can include, but are not limited to, required time to respond to a request, availability, language provided by application, and throughput. Typically, the SLAs specify two parameters for any performance metric, average and threshold. Depending on the performance metric, the threshold could be based on a variety of factors, including, without limitation, a maximum permissible value (e.g., for response time) and a minimum tolerable value (e.g., for throughput). In some embodiments, the threshold value can indicate a hard limit that, when breached, may result in harmful consequences for the cloud provider and/or its clients. The average value of a performance metric indicates the ability of a cloud provider to guarantee desirable quality of service over relatively long periods of time. For ease of subsequent discussion of an application's SLA, a response time performance metric is used. However, one of ordinary skill in the art having the benefit of the present disclosure would appreciate that the processes and functions performed by the system 100 can be extrapolated easily to performance metrics other than response time.

The application manager 140 can trade off an application's performance for savings in power consumption by powering down one or more selected servers 150 and redistributing excess workload created as a result of powering down the selected servers 150, operating each of the servers 150 that host the application at a lower frequency/voltage using dynamic voltage and frequency scaling schemes, or a combination thereof. Thus, one role of the application manager 140 is to determine an acceptable number of servers 150 and/or an acceptable value of frequency/voltage for maximizing the reduction in electricity consumption without compromising the application's SLA. A key question that the application manager 140 can address is how to maximize electricity savings by allowing the application's response time to temporarily degrade to the maximum acceptable response time. Another key issue that the application manager 140 can resolve is to determine the time duration, as a fraction of the peak power grid load duration, for which threshold level of performance of the application is acceptable. The application manager 140 communicates this information together with the power savings that the application manager 140 can achieve to the site broker 130.

The site broker 130 is communicably coupled to the smart meter 180 to receive the electricity pricing information from the utility 170. The site broker 130 uses the information provided by the application manager(s) 140 and the electricity pricing information received from the smart meter 180 to sequence the execution of the application(s) at reduced performance levels to achieve electricity consumption and/or costs savings associated with reduced electricity consumption. Additionally, the site broker 130 can select application(s) to migrate to other clouds 120 to reduce electricity consumption and/or costs savings associated with the reduced electricity consumption at the site broker's cloud 120. The site broker 130 may analyze the application(s) to determine a sequence of execution at reduced performance levels and to identify application(s) to move to another cloud 120 in response to an event, such as a peak power grid load situation. For example, the site broker 130 may perform this analysis in response to receiving a command from the utility 170 (via the smart meter 180) to reduce electricity consumption. The utility 170 may also assign the cloud 120 budget of electricity that the cloud 120 can consume over a certain time period and a penalty for exceeding the budget for that time period. The site broker 130 can use that information to sequence the application(s) and to identify one or more application(s) to move to another cloud 120. For example, as part of this analysis, if the utility 120-1 that serves cloud 120-1 is experiencing a peak load situation, the site broker 130-1 may select one or more applications hosted by that cloud 120-1 to migrate to another cloud, such as cloud 120-2, that is not experiencing a peak load situation.

The site broker 130 may also perform the analysis of the application(s) periodically. For example, the site broker 130 may periodically evaluate the costs incurred by operating the servers 150 (and other equipment) to run the application(s) and attempt to reduce or minimize these costs. For example, two clouds 120-1 and 120-2 may be located in different geographic locations but in similar or the same time zones such that the two clouds 120-1 and 120-2 experience peak load grid situations at approximately the same time. However, the price of electricity may be greater for the cloud 120-1 than the price of electricity for the cloud 120-2. In this example, the site broker 130-1 may identify one or more application(s) to move from the cloud 120-1 to the cloud 120-2.

The selection of application(s) to move from one cloud 120 to another cloud 120 is performed in a manner to minimize any adverse impact on application performance. In certain exemplary embodiments, the site broker 130 may work to minimize the number of applications migrated to other clouds 120 by selecting for migration applications that provide the least amount of electricity (or cost) savings when operated at reduced performance levels. For example, the cloud 120-1 may host a first application A that consumes 10 kilowatts (kW) over a certain time period and a second application B that consumes 15 kW over the time period. The first application A may consume 8 kW over the same time period if operated at reduced performance levels and the second application B may consume 11 kW over the same time period if operated at reduced performance levels. In this example, the first application A can save 2 kW, while the second application B can save 4 kW. Thus, the site broker 130-1 may select the first application A for migration and operate the second application B at reduced performance levels.

In another example, the site broker 130 may work to minimize the number of applications migrated to other clouds 120 by selecting for migration the applications that consume the most electricity. In the above example, the site broker 130-1 may select the second application B for migration and operate the first application A at reduced performance levels. The site broker 130 can consider factors other than electricity and cost savings to identify application(s) for migration to another cloud 120, such as geographical constraints based on the attributes of the applications and data associated with the applications.

As briefly disclosed above, the site broker 130 for each cloud 120 is communicably coupled to the HCB 110 that facilitates moving a computer application from one cloud 120 to another cloud 120. The site brokers 130 can send the information regarding any application(s) selected to be migrated to another cloud 120 to the HCB 110. The HCB 110 can then determine to which cloud 120 the application(s) should be migrated. The HCB 110 can consider constraints, such as incompatibility constraints between an application and a cloud 120. The HCB 110 can also consider capacity constraints associated with other clouds 120 that are under consideration. The HCB 110 can initiate the migration of the application to the determined cloud 120.

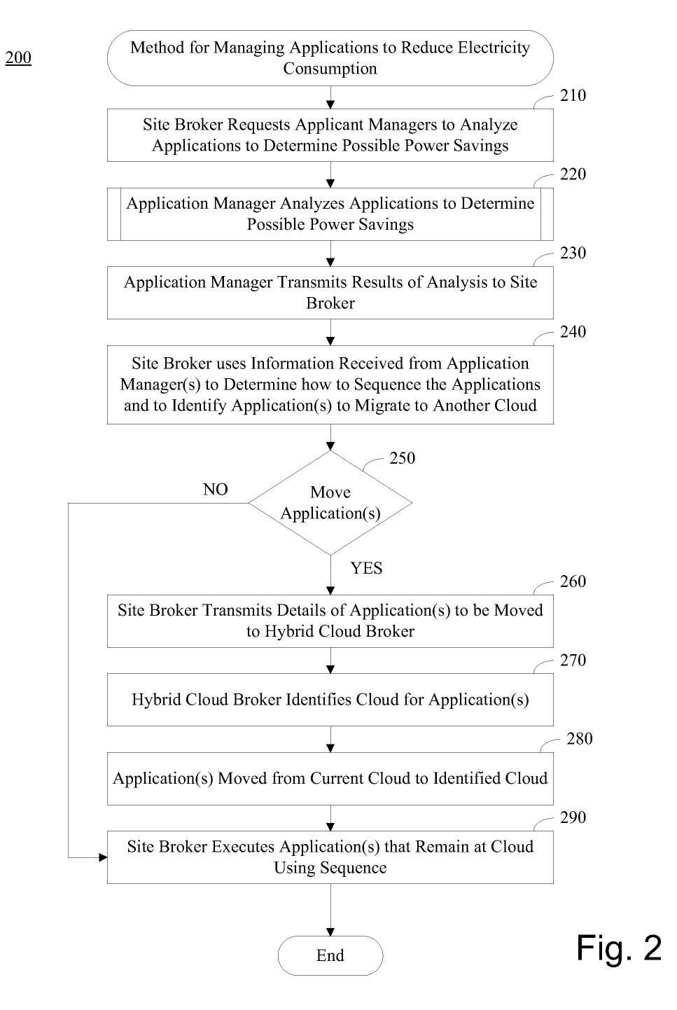

The exemplary system 100 is described hereinafter with reference to the exemplary methods illustrated in FIGS. 2-4. The exemplary embodiments can include one or more computer programs that embody the functions described herein and illustrated in the appended flow charts. However, it should be apparent that there could be many different ways of implementing aspects of the exemplary embodiments in computer programming, and these aspects should not be construed as limited to one set of computer instructions. Further, a skilled programmer would be able to write such computer programs to implement exemplary embodiments based on the flow charts and associated description in the application text. Therefore, disclosure of a particular set of program code instructions is not considered necessary for an adequate understanding of how to make and use the exemplary embodiments. Further, those skilled in the art will appreciate that one or more acts described herein may be performed by hardware, software, or a combination thereof, as may be embodied in one or more computing systems.

FIG. 2 is a flow diagram of a method 200 for reducing electricity expenditure associated with hosting applications in a cloud computing environment, in accordance with certain exemplary embodiments. The exemplary method 200 is described in terms of reducing electricity expenditure without compromising an SLA having a response time performance metric. As mentioned above, other performance metrics can also be used without departing from the scope and spirit of the present invention.

For the purpose of this exemplary method 200, let the SLA for an application i specify an average response time of R^{avg} and a maximum acceptable response time of R^{max}. Let P and P′ (P′<P) indicate the power (i.e., electricity) consumption of application i for achieving response times of R^{avg} and R^{max}, respectively, where R^{avg}<R^{max}. The method 200 can exploit the leeway between the values of the two SLA parameters (i.e., R^{avg} and R^{max}) to reduce the power expenditure during peak power grid load situations while maintaining the quality of service specified in the SLA. For the purposes of the following discussion, whenever an application is stretched to operate at a level where the request response time degrades to, or approaches, R^{max}, the application is said to be operating at “threshold-SLA levels;” and when the application operates at a level where the request response time is R^{avg}, the application is said to be operating at “standard-SLA levels.”

Referring now to FIGS. 1 and 2, in step 210, the site broker 130 makes a request to each application manager 140 in the site broker's cloud 120 to analyze its application(s) to determine how much electricity that application manager 140 can save. The site broker 130 can make this request in response to a cloud 120 receiving a demand from a utility 170 to reduce electricity consumption. The site broker 130 can also make this request in response to the cloud 120 receiving an increase in electricity pricing from the utility 170, for example as part of a DR program. Alternatively or in addition, the site broker 130 can make this request based on a time period. For example, if peak load conditions occur at or near the same hours everyday, the site broker 130 can be configured to make the request to the application managers 140 each day prior to those hours. In addition, the site broker 130 may make the request in response to a command from an administrator of the cloud provider.

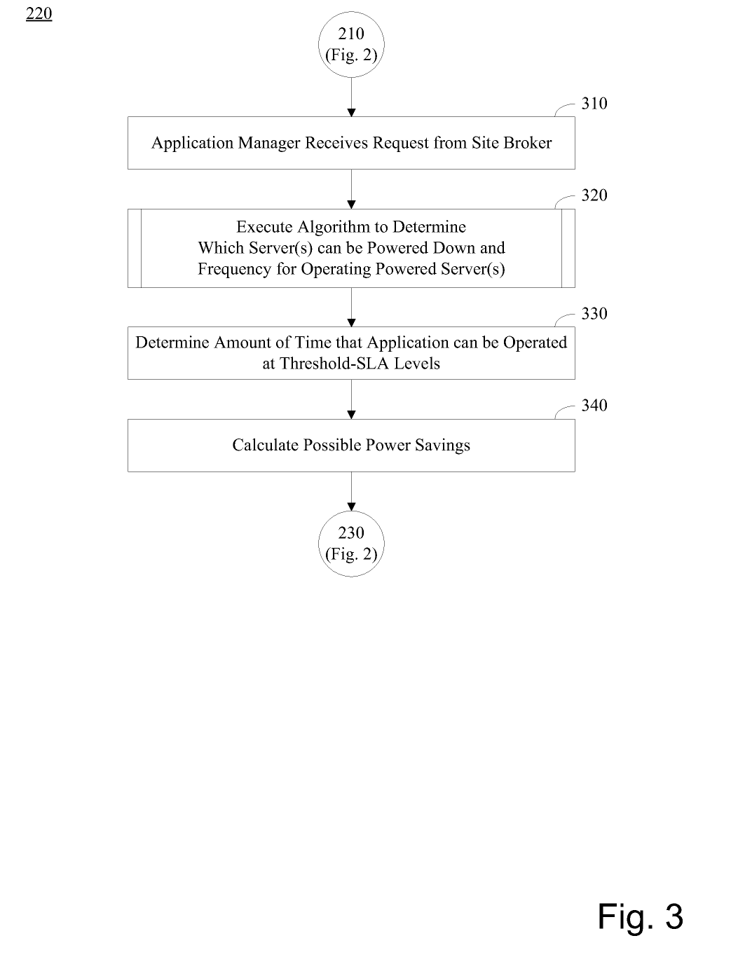

In step 220, each application manager 140 within the cloud 120 analyzes its application(s) to determine how much electricity could be saved. The application manager 140 determines whether one or more servers 150 can be powered down. The application manager 140 also determines a frequency at which the powered servers 150 operate. The application manager 140 also determines how long an application can be reduced to a lower performance level without compromising the SLA for that application. The application manager 140 uses the aforementioned information to determine how much electricity can be saved. Step 220 is described further detail in connection with FIG. 3.

FIG. 3 is a flow diagram of a method 300 for analyzing an application to determine possible electricity savings, in accordance with certain exemplary embodiments, as referenced in FIG. 2. Referring now to FIGS. 1 and 3, in step 310, the application manager 140 receives the request from the site broker 130. In step 320, the application manager 140 executes an algorithm to determine which servers 150 can be powered down and at what frequency the powered servers 150 can be operated at in order to conserve electricity.

The response time for responding to requests can be modeled to relate an application i and the operating frequency of the servers 150 for the application i. Let f^{max} represent the maximum frequency at which the servers 150 can operate. Let μ^{max} represent the service rate of the j^{th} server when operating at f^{max}. The service rate “μⱼ” of the j^{th} server when operating at frequency “fⱼ” (fⱼ<f^{max}) then becomes:

$${μ}_{j} = \frac{{μ}_{j}^{ma x} {f}_{j}}{{f}^{m ax}} .$$

The power consumption (i.e., electricity consumption) “Pⱼ” can be modeled mathematically as αⱼ+βⱼfⱼ³, where αⱼ and βⱼ are standard parameters obtained from regression tests on empirically collected data. The application manager 140 can determine the operating frequency fⱼ of each server j and the number of active servers so that the aggregate power consumption is minimized (or at least acceptable) and the response time criteria of the application operating at threshold-SLA levels are met. Thus, the objection function the application manager 140 would like to solve is shown below in Equation 1. Let Xⱼ be a variable, λⱼ represents the number of requests handled by the j^{th} server, and λᵢ represents the number of requests application i receives, Rⱼ represents the response time for the j^{th} server to respond to a request, and R^{max} represents the maximum response time defined by the SLA.

$$Min {{\sum }_{j = 1}}^{N} {X}_{j} ( {α}_{j} + {β}_{j} {f}_{j}^{3} ) \\ Subject to \text{:} \\ {\sum }_{j = 1}^{N} {X}_{j} {λ}_{j} = {λ}_{i} \\ {R}_{j} ( {μ}_{j} , {λ}_{j} ) \leq {R}^{ma x} \qquad Equation 1$$

According to the M/M/1 queuing model,

$${R}_{j} = \frac{1}{{μ}_{j} - {λ}_{j}} .$$

### Substituting

$${μ}_{j} = \frac{1}{\frac{{μ}_{j}^{ma x} {f}_{j}}{{f}_{ma x}} - {λ}_{j}}$$

and reorganizing

$${f}_{j} = \frac{{f}^{ma x}}{{μ}_{j}^{ma x}} ( {λ}_{j} + \frac{1}{{R}_{ma x}} ) .$$

On substituting the expression of fⱼ the objective function becomes:

### Equation 2:

$$Min {\sum }_{j = 1}^{N} {X}_{j} ( {α}_{j} + {{β}_{j} ( \frac{{f}^{m ax}}{{μ}_{j}^{ma x}} ( λ j + \frac{1}{{R}^{ma x}} ) )}^{3} )$$

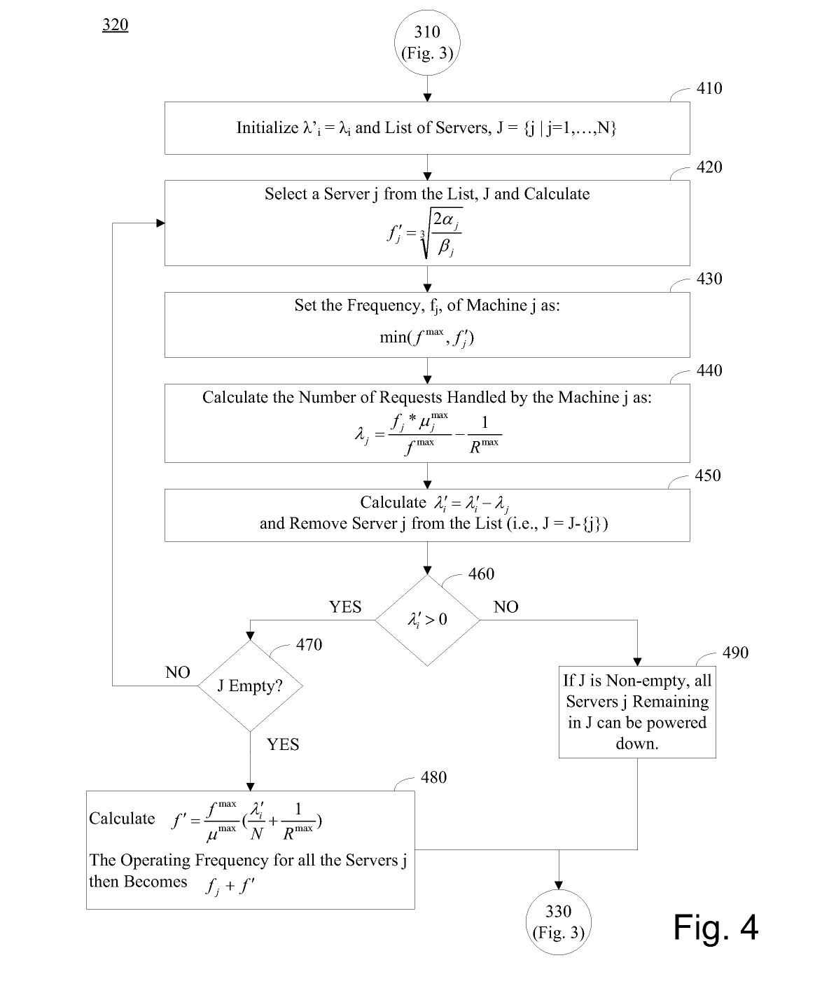

The objection function shown in Equation 2 is untenable for conventional solvers. Thus, the application manager 140 uses the following heuristic algorithm, illustrated in FIG. 4, to solve the problem in a realistic amount of time.

FIG. 4 is a flow diagram of a method 320 for executing an algorithm to determine which (if any) server(s) can be powered down and a frequency for operating powered server(s), in accordance with certain exemplary embodiments, as referenced in FIG. 3. Referring to FIGS. 1 and 4, in step 410, the application manager 140 initializes the number of requests for the application λᵢ′=λᵢ and a list of servers, J={j|j=1, . . . , N} for a number “N” servers in a cloud 120.

In step 420, the application manager 140 selects a server j from the list J and calculates:

$${f}_{j}^{′} = \sqrt[3]{\frac{2 {α}_{j}}{{β}_{j}}}$$

for the server j.

In step 430, the application manager 140 sets the operating frequency, fⱼ, of server j to the minimum of the maximum frequency f^{max} for server j and the calculated fⱼ′.

In step 440, the application manager 140 calculates the number of requests handled by machine j using Equation 3 below:

$${λ}_{j} = \frac{{f}_{j} * {μ}_{j}^{ma x}}{{f}^{ma x}} - \frac{1}{{R}^{ma x}} \qquad Equation 3$$

In step 450, the application manager 140 subtracts the requests handled by server j from the number of requests for application i. In the first iteration of this algorithm, the application manager 140 subtracts the requests λⱼ handled by the first selected server j from the total number of requests received by the application, λᵢ. In subsequent iterations (if any), the application manager 140 subtracts requests handled by subsequently selected servers from the remaining number of requests λᵢ′ for the application i. That is, the application manager 140 calculates λᵢ′=λᵢ′−λⱼ for each iteration and maintains the updated λᵢ′. After updating λᵢ′, the application manager 140 removes the server j from the list J.

In step 460, the application manager 140 determines whether the updated λᵢ′ is greater than zero indicating that the application i has more requests than can be handled by the previously analyzed server(s). If the application i has remaining requests (i.e., λᵢ′>0), the method 320 follows the “YES” branch to step 470. Otherwise, the method 320 follows the “NO” branch to step 490.

In step 470, the application manager 140 determines whether the list J is empty and thus all of the servers in J have been analyzed in steps 420-450. If the list J is empty, then the “YES” branch is followed to step 480. Otherwise, the “NO” branch is followed back to step 420, where another server is selected from the list J and analyzed in steps 430-450.

In step 480, the application manager 140 calculates the operating frequency for each of the servers j that were in the list J. In certain exemplary embodiments, the application manager 140 uses Equation 4 below to calculate f′ for each server j. The application manager 140 adds the calculated f′ to the frequency fⱼ calculated for that server j in step 430. Thus, the operating frequency for each server j is fⱼ+f′.

$${f}^{′} = \frac{{f}^{ma x}}{{μ}^{m ax}} ( \frac{{λ}_{i}^{′}}{N} + \frac{1}{{R}^{ma x}} ) \qquad Equation 4$$

In step 490, if there are any remaining servers j in J after λᵢ′ is reduced to zero (or less), then all servers j remaining in J can be powered down as the previously analyzed servers can handle the requests for the application i while the application i is operated at threshold-SLA levels.

After either step 470 or 490 is performed, the method 320 proceeds to step 330, as referenced in FIG. 3. Referring back to FIGS. 1 and 3, in step 330, the application manager 140 determines an amount of time “τᵢ” that the application i can be operated at threshold-SLA levels. Let “T” represent the duration for which peak electric grid load situation exists. This duration T may be communicated to the application manager 140 by the site broker 130. Also, let “T” represent the time period immediately following T. As the application i has to maintain an average response time R^{avg} over T+T′ (per SLA), Equation 5 below must hold true:

$$\frac{( {λ}_{i} {τ}_{i} ) {R}_{ma x} + ( {λ}_{i } ( T - {τ}_{i} ) ) {R}^{avg} + ( {\hat{λ}}_{i} {T}^{′} ) {R}^{′}}{( {λ}_{i} T ) + ( {\hat{λ}}_{i} {T}^{′} )} = {R}^{avg} \qquad Equation 5$$

In Equation 5, λᵢ is the load (i.e., number of requests received by application i) during time period T (i.e., the time period when peak power grid load situation occurs) and \hat{λ}ᵢ is the forecasted load for the time period T′ immediately following T. The objective of the application manager 140 in this step 470 is to find τᵢ. However, Equation 5 has additional unknown variable R′. A high τᵢ is desirable, although τᵢ can be less than time period T. During time period T′, a goal of the application manager 140 (or the site broker 130) is to compensate for the deviation between R^{avg} and R^{max} that occurs during time period T. This can be accomplished by operating the application i at maximum frequencies so that the response times are minimized during time period T′. Thus, R′ can be approximated using Equation 6 below:

$$\frac{1}{{μ}^{ma x} - \frac{λ i}{N }} \qquad Equation 6$$

Substituting the value of R′ in Equation 5 results in Equation 7 below:

$${τ}_{i} = \frac{{R}^{avg} ( {λ}_{i} T + {\hat{λ}}_{i} {T}^{′} ) - \hat{λ} {T}^{′} \frac{1}{{μ}^{ma x} - \frac{{λ}_{i}}{N}} - {λ}_{i} {TR}^{avg} }{{λ}_{i} ( {R}^{ma x} - {R}^{avg} )} \qquad Equation 7$$

The application manager 140 can solve Equation 7 to determine the amount of time τᵢ that the application i can be operated at threshold-SLA levels.

In step 330, the application manager 140 uses the analysis completed in steps 320 and 330 to determine the amount of power that can be saved by operating the application i at the threshold-SLA levels for time period τᵢ. The application manager 140 takes into account the number of servers that will be operating, the frequency that each server will be operating at, the time period τᵢ that the application can execute at threshold SLA levels, and the amount of electricity needed to operate the application at threshold-SLA levels and at standard-SLA levels when making this calculation. After step 330 is performed, the method 220 proceeds to step 230, as referenced in FIG. 2.

Referring back to FIGS. 1 and 2, in step 230, the application manager 140 transmits the results of the analysis in step 210 to the site broker 130. The application manager 140 can send the amount of electricity that can be saved by operating the application i at the threshold-SLA levels and the amount of time τᵢ that the application i can be operated at the threshold-SLA levels to the site broker 130.

In step 240, the site broker 130 uses the information received from each application manager 140 to determine how to sequence the applications and to identify application(s), if any, to move to another cloud 120. The site broker 130 can divide the time period T for which the cloud 120 is in a peak load situation into a number “N” of time slots. For each time slot, the site broker 130 can assign certain applications to operate at reduced performance levels during the time slot, while assigning certain other applications to operate at normal performance levels during the time slot. The site broker 130 can sequence the applications such that a power budget is met for each time slot. If the power budget cannot be met, then the site broker 130 may identify one or more applications to be migrated to another cloud 120.

To give a simple example, a cloud 120 may host four applications and have a reduced power budget of 16 kilowatts (kW) for a four hour period resulting from a peak load situation. The site broker 130 may divide the four hour time period into four slots of one hour each. The site broker 130 may then determine how to sequence the four applications to meet the power budget and the SLAs for each application. Based on the analysis by the application manager 140 for each application, a first application may be able to execute at a reduced performance level for one hour, a second application may be able to operate at a reduced performance level for two hours, a third application may be able to operate at a reduced performance level for a half hour, and a fourth application may be able to operate at a reduced performance level for all four hours. The site broker 130 can use this information, along with the power requirements of the applications at normal and reduced performance levels to assign the applications to either normal or reduced performance levels for each time slot. In this example, the first application may be assigned to execute at reduced performance the first time slot while executing at a normal performance level for slots 2-4. Similarly, the second application may be assigned to execute at a reduced performance level during the second time slot while executing at a normal performance level for slots 1 and 3-4. The third application may be assigned to execute at a reduced performance level for half of the third time slot while executing at a normal performance level for slots 1-2, and 4. The fourth application may be executed at a reduced level for all four time slots. If there is no way to sequence a time slot such that the power budget is met and the SLAs for the applications are met, then the site broker 130 can identify one or more applications for migrating to aotehr cloud 120.

Let Pᵢ represent the power consumed by application i if operating at reduced performance levels during peak power grid load situation; Pᵢ′ represents the power consumed by application i if operating at normal performance levels; P_{budget} represents the average power budget during a peak power grid load situation; and τᵢ represents the acceptable time duration for executing application i at reduced performance levels during a peak power grid load situation. Further, let Xᵢ indicate whether application i is migrated to another cloud, where Xᵢ is “1” if migrated and Xᵢ is “0” if the application i is not migrated. Also, let Yᵢₜ indicate whether application i is executing at reduced performance level at time slot t, where Yᵢₜ is “1” if the application i is executing at reduced performance level at time slot t and Yᵢₜ is “0” if the application i is not executing at reduced performance level at time slot t.

The site broker 130 divides the time period T into N time slots t, each having a duration of δ. Thus, N=T/δ. Let nᵢ=τᵢ/δ, which is the ratio of time that application i is executing at a reduced performance level to the duration of a time period. Further, let Eᵢ represent the amount of power consumed by application i in one time slot and E_{budget} represent the average power consumed by all applications in one time slot. Then,

$${E}_{i} = \frac{{P}_{i}}{{n}_{i}} , {E}_{i}^{′} = \frac{{P}_{i}^{′}}{N - {n}_{i}} , and {E}_{budget} = \frac{{P}_{budget}}{N} .$$

Mathematically, the problem that the site broker 130 addresses can be formulated as:

$$Min {\sum }_{i} {X}_{i}$$

$$Subject to \text{:}$$

$${\sum }_{t = 1}^{N} {Y}_{it} = {n}_{i} ( 1 - {X}_{i} ) \qquad ∀ i$$

$${Y}_{it} \leq ( 1 - {X}_{i} ) \qquad ∀ i , t$$

$${\sum }_{i} {E}_{i} {Y}_{it} + {\sum }_{i} {E}_{i}^{′} ( 1 - {Y}_{it} ) \leq {E}_{budget} ∀ t$$

Computational time to solve this problem grows exponentially with the problem size, as the problem is NP-hard. A heuristic that can provide a sufficient solution in a reasonable amount of time is to sort the applications in decreasing order based on Equation 8 below:

$$\frac{( {E}_{i}^{′} - {E}_{i} ) * {n}_{i}}{{E}_{i}^{′} * ( N - {n}_{i} )} \qquad Equation 8$$

The numerator of Equation 8 indicates the total power that can be conserved for an application i, for example when the power grid experiences peak load. This power savings is due to the application operating at threshold-SLA levels for a fraction of time within the period T and is an indicator of the benefits of retaining application i for execution by the cloud 120. The denominator of Equation 8 indicates the nominal power consumed by an application i during the time period T, when operating under standard-SLA levels and is an indicator of the cost of retaining application i for execution by the cloud 120. Thus, it can be more beneficial to keep the applications having a higher value for Equation 8 at the cloud 120, while migrating those applications having lower values for Equation 8 to another cloud 120.

The site broker 130 may also utilize a threshold, such as a user-defined threshold, for identifying applications to migrate to another cloud 120. For example, those applications having a value for Equation 8 that fall below a certain threshold may be identified for migration to another cloud 120.

Let I′ represent the set of applications that the site broker 130 elected to retain at the cloud 120. The site broker 130 can sequence the applications in I′ and identify the time instances within the time period T when the applications should operate at threshold-SLA levels. Let the power consumption of each application i be represented using blocks of two sizes—i₁ and i₂. A block with size i₁ represents an application i operating under standard-SLA conditions. A block with size i₂ represents an application i operating under threshold-SLA conditions. Because i₁′>i₂′, and i₁>i₂, a block with size i₁′ can be scheduled for execution together with a block of size i₂ and blocks with size i₁ can be scheduled for execution together with a block of size i₂′. Additionally, there may be blocks of size i₁′ that are scheduled for execution together with blocks of size i₁. This results in three blocks of sizes: i₁′+i₂, i₁+i₂′, and i₁′+i₁ (or i₂′+i₂). Thus, at iteration l, there would be l+1 blocks of different sizes. If the size of any of the blocks exceeds the power budget, E_{budget}, the algorithm may terminate and the site broker 130 may identify one or more applications for migration to another cloud 120. All remaining applications are considered candidates for migration to another cloud 120. The site broker 130 can select applications for migration based on their values for Equation 8, for example by selecting those with a lower value for Equation 8 first.

In step 250, if the site broker 130 identified any applications to migrate to another cloud 120, the “YES” branch is followed to step 260. Otherwise, the “NO” branch is followed to step 290. In step 260, the site broker 130 transmits information regarding the applications selected to be migrated to another cloud 120 to the HCB 110.

In step 270, the HCB 110 identifies another cloud 120 for each of the selected applications. The HCB 110 selects a cloud 120 from available (and suitable for hosting the application) clouds 120 that minimizes degradation of the performance metric for the application. The HCB 110 can take many factors into consideration when selecting a cloud to migrate the applications to. The HCB 110 can take into consideration compatibility issue between the clouds 120 and the applications. The HCB 110 can also take into consideration the amount of data that needs to be transmitted from the current cloud 120 hosting the application to the cloud 120 that the application is going to be hosted. The HCB 110 can also take into consideration data traffic between the two clouds 120. The HCB 110 can also take into consideration the conditions of the other clouds 120. For example, the utility 170 for one of the other clouds 120 may also be experiencing a peak load condition. The HCB 110 can also take into consideration the price of electricity at each of the other clouds 120. For example, the higher cost associated with the peak load condition at the current cloud may still be lower than the cost of electricity at other clouds.

In step 280, the HCB 110 initiates the migration of the application(s) from the current cloud 120 where the application(s) is hosted to another cloud 120. The HCB 100 can interact with the site broker 130 at each cloud 120 to initiate the migration. The site broker 130 of the current cloud 120 can then migrate the application(s) to the other cloud 120.

In step 290, the site broker 130 interacts with the application managers 140 to operate the applications remaining at the cloud 120 based on the sequence generated in step 240. After the peak grid load condition lapses, the site broker 130 can interact with the application managers 140 to return to normal operation. The site broker 130 may also initiate the return of the application(s) that were migrated to another cloud 120 in step 280.

The exemplary methods and acts described in the embodiments presented previously are illustrative, and, in alternative embodiments, certain acts can be performed in a different order, in parallel with one another, omitted entirely, and/or combined between different exemplary embodiments, and/or certain additional acts can be performed, without departing from the scope and spirit of the invention. Accordingly, such alternative embodiments are intended to be within the scope of the instant disclosure.

The exemplary embodiments can be used with computer hardware and software that performs the methods and processing functions described above. As will be appreciated by those skilled in the art, the systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc. In some embodiments, a computing device may load or read software from a computer-readable media for execution by a processor such as, without limitation, a microprocessor, microcontroller, or the like, within the computing device. Such software provides instructions which, when executed by the processor, cause the processor read data from computer-readable media and perform one or more functions thereon.

Although specific embodiments have been described above in detail, the description is merely for purposes of illustration. It should be appreciated, therefore, that many aspects described above are not intended as required or essential elements unless explicitly stated otherwise. Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

What is claimed is:

1. A computer-implemented method for reducing electricity consumption for a group of computers hosting a plurality of applications, comprising:
analyzing, by a computer, each application to determine a time duration that the application can be executed at a reduced performance level without compromising at least one performance metric associated with the application;
generating, by a computer, a sequence for executing the applications at reduced performance levels for a time period based on the time duration for each application, whereby total electricity consumed by the applications meets an electricity usage budget throughout the time period; and
executing, by a computer, the applications according to the sequence.

2. The computer-implemented method of claim 1, wherein the time period is based on a peak power grid load condition.

3. The computer implemented method of claim 1, further comprising the steps of:
determining, for each application, an amount of electricity that can be conserved by executing that application at the reduced performance level;
selecting, based on the amount of electricity that can be conserved for each application, at least one of the applications to be migrated to another group of computers; and
migrating the at least one of the applications to another group of computers.

4. The computer-implemented method of claim 3, wherein determining an amount of electricity that can be conserved by executing an application at the reduced power level comprises:
determining whether one or more computers in the groups of computers that host the application can be powered down without compromising the at least one performance metric; and
determining how much electricity can be conserved by powering down the one or more computers.

5. The computer-implemented method of claim 4, further comprising determining an operating frequency for computers in the group of computers that hosts the application and remains powered on, wherein determining how much electricity can be conserved further comprises determining how much electricity can be conserved by operating the computers that host the application and remains powered on at the operating frequency.

6. The computer-implemented method of claim 1, wherein generating a sequence for executing the applications at reduced performance levels for a time period comprises:
dividing the time period into a plurality of time slots; and
for each time slot, assigning each application to execute at either a normal performance level or at the reduced performance level.

7. The computer-implemented method of claim 6, wherein generating a sequence for executing the applications at reduced performance levels for a time period further comprises:
determining, for each time slot, a total amount of electricity that will be consumed by executing the applications based on the assignments;
determining, for each time slot, whether the total amount of electricity that will be consumed by executing the applications meets the electricity usage budget for each time slot;
in response to a determination that the total amount of electricity that will be consumed by executing the applications does not meet the electricity usage budget for at least one of the time slots, identifying one or more of the applications to transfer to a second group of computers; and
transferring the identified one or more applications to the second group of computers.

8. The computer-implemented method of claim 7, wherein identifying one or more of the applications to transfer to a second group of computers comprises:
determining, for each application, an amount of electricity that can be conserved by executing that application at the reduced performance level; and
identifying the one or more of the applications that can conserve the least amount of electricity when executed at the reduced performance level.

9. A computer-implemented method for reducing electricity consumption for a first group of computers hosting a plurality of applications, comprising:
receiving, by a computer, a request to reduce an amount of electricity consumed by the first group of computers to a level below a budgeted amount of electricity for a time period;
analyzing, by a computer, each application to determine a time duration that the application can be executed at a reduced performance level without compromising at least one performance metric associated with the application;
determining, by a computer, based at least on the time duration that each application can be executed at a reduced performance level, whether the applications can be executed in a sequence of varying performance levels to meet the budgeted amount of electricity; and
based on a determination that the applications cannot be sequenced to meet the budgeted amount of electricity:
selecting, by a computer, one or more of the applications to be transferred to a second group of computers;
transferring, by a computer, the selected one or more of the applications to the second group of computers; and
based on a determination that the applications can be sequenced to meet the budgeted amount of electricity:
generating, by a computer, a sequence for executing the applications at reduced performance levels based on the time duration that each application can be executed at a reduced performance level; and
executing, by a computer, the applications according to the generated sequence.

10. The computer-implemented method of claim 9, further comprising:
based on a determination that the applications cannot be sequenced to meet the budgeted amount of electricity:
generating a sequence for executing the applications remaining at the first group of computers at reduced performance levels based on the time duration that each application can be executed at a reduced performance level; and
executing the applications remaining at the first group of computers according to the sequence.

11. The computer-implemented method of claim 9, wherein selecting one or more of the applications to be transferred to a second group of computers comprises:
determining, for each application, an amount of electricity that can be conserved by executing that application at the reduced performance level for the time duration; and
selecting, based on the amount of electricity that can be conserved for each application, the one or more of the applications to be transferred to the second group of computers.

12. The computer-implemented method of claim 9, wherein selecting one or more of the applications to be transferred to a second group of computers comprises:
computing, for each application, a first amount of electricity that can be conserved by executing the application at the reduced performance level;
computing, for each application, a second amount of electricity that the application would consume while operating at a normal performance level;
computing, for each application, a ratio of the first amount to the second amount; and
selecting the one or more applications based on the computed ratios.

13. A system, comprising:
a plurality of computers for hosting a plurality of applications;
at least one application manager that manages execution of at least one of the applications on a portion of the computers; and
a site broker communicably coupled to the at least one application manager and operable to determine a sequence for executing the applications in a manner to not exceed a power budget for a time period without compromising a performance metric associated with each application, each application being executed in the sequence at a reduced performance level for at least a portion of the time period.

14. The system of claim 13, wherein the at least one application manager is operable to determine, for each application managed by the application manager, a time duration that the application can execute at the reduced performance level without compromising the performance metric for that application.

15. The system of claim 13, wherein the at least one application manager is operable to determine, for each application managed by the application manager, whether one or more computers hosting the application can be powered down while the application is being executed at the reduced performance level without compromising the performance metric for that application.

16. The system of claim 15, wherein the at least one application manager is operable to determine, for each application managed by the application manager, an operating frequency for one or more computer that remain powered.

17. The system of claim 13, wherein the site broker is further operable to select one or more of the applications to be transferred from the plurality of computers to a cloud computing environment.

18. The system of claim 17, further comprising a hybrid cloud broker operable to select the cloud computing environment from a set of available cloud computing environments.

19. The system of claim 18, wherein the at least one application manager is operable to determine, for each of the at least one applications, an amount of electricity that can be saved by executing the application at the reduced performance level for the at least a portion of the time period and further operable to transmit the determined amount to the site broker.

20. The system of claim 19, wherein the site broker selects the one or more of the applications to be transferred from the plurality of computers to the cloud computing environment based on the determined amount of electricity that can be conserved for each of the applications.
